(19) United States
(12) Patent Application Publication
(10) Pub. No.: US 2012/0192168 A1
(43) Pub. Date: Jul. 26, 2012

(54) COMPILER DEVICE

(76) Inventors: Kenji Funaoka, Kanagawa-ken (JP); Mayuko Koezuka, Tokyo (JP); Akira Kuroda, Kanagawa-ken (JP); Hidenori Matsuzaki, Tokyo (JP)

(21) Appl. No.: 13/419,657

(22) Filed: Mar. 14, 2012

Related U.S. Application Data
(63) Continuation of application No. PCT/JP2010/000710, filed on Feb. 5, 2010.

(51) Int. Cl. G06F 9/45

(52) U.S. Cl. 717/155; 717/140

(57) ABSTRACT

A compiler device 10 includes: an input unit inputting a data flow graph including a set of nodes and a set of edges and information indicating a range of values that can be taken by data flowing along each edge; and a determination unit determining, from among a plurality of different types of hardware resources, a hardware resource to which a first node can be assigned based on the first node type and information indicating the range of values that can be taken by data flowing along a first edge connected to the first node. The compiler device 10 makes it possible to efficiently utilize hardware resources without losing data accuracy.

### CROSS-REFERENCE TO RELATED APPLICATION

This application is a continuation of International Application No. PCT/JP2010/000710, filed Feb. 5, 2010, the entire contents of which are incorporated herein by reference.

### FIELD

Embodiments described herein relate generally to a field of compilation and, more particularly, to arithmetic mapping.

### BACKGROUND

Compilation is a technique of converting a source code that human creates using a programming language into a computer-executable form (object code).

As a technique for making computer processing more efficient, there is known one disclosed in PTL 1. In the technique of PTL 1, representation of an object code is optimized to make computer processing more efficient. This technique uniquely assigns an arithmetic operation to an instruction having the minimum arithmetic accuracy within a range within which an overflow does not occur in an arithmetic result so as to optimize memory usage efficiency. Behind this technique is the fact that when a stack machine like Java® is used, the arithmetic accuracy and stack size (memory size) to be used in an arithmetic operation are proportional to each other. However, in the case where a plurality of hardware resources having different features, assignment of an arithmetic operation to a hardware resource having the minimum arithmetic accuracy does not always contribute to the efficiency of computer processing.

As a technique for making computer processing more efficient, there is known one disclosed in NPL 1. In the technique of NPL 1, representation of an object code is optimized to make computer processing more efficient. This technique organizes, when realizing a given arithmetic operation group into a SIMD (Single Instruction Multiple Data) instruction, the arithmetic operation group into an SIMD instruction having a smaller arithmetic accuracy as long as the accuracy of the arithmetic result is tolerated so as to optimize arithmetic operation execution efficiency. Behind this technique is the fact that an SIMD instruction having a smaller arithmetic accuracy can perform a larger number of arithmetic operations at a time. However, in the case where a plurality of hardware resources having different features, a reduction in the number of instructions does not always contribute to the efficiency of computer processing.

### BRIEF DESCRIPTION OF THE DRAWINGS

FIG. 1 is a view illustrating a configuration example of a compiler system according to an embodiment.

FIG. 2 is a view schematically illustrating the configuration of a compiler device according to an embodiment with functional components.

FIG. 3 is a flowchart illustrating an operation of the compiler device.

FIG. 4 is a flowchart illustrating an operation of a determination unit.

FIG. 5 is a view illustrating an example of a source program.

FIG. 6 is a view illustrating an example of a data flow graph.

FIG. 7 is a view illustrating the data flow graph and data ranges of some edges in the data flow graph.

FIG. 8 is a table representing an example of information output from a data dependency analysis unit.

FIG. 9 is a view illustrating the data flow graph and data ranges of all the edges in the data flow graph.

FIG. 10 is a table representing an example of information output from a data range analysis unit.

FIG. 11 is a view illustrating an example of a hardware resource.

FIG. 12 is a correspondence table among a hardware resource, type of an arithmetic operation, and data range stored in a first storage unit.

FIG. 13 is a table representing information output from the determination unit.

FIG. 14 is a table representing an example of hardware resource management information stored in a second storage unit.

FIG. 15 is a table representing information output from an assignment unit.

FIG. 16 is a table representing example of information input to the determination unit.

FIG. 17 is a correspondence table stored in the first storage unit and representing a correspondence among the hardware resource, type of the arithmetic operation, and bit width.

FIG. 18 is a view illustrating a determination device according to the embodiment.

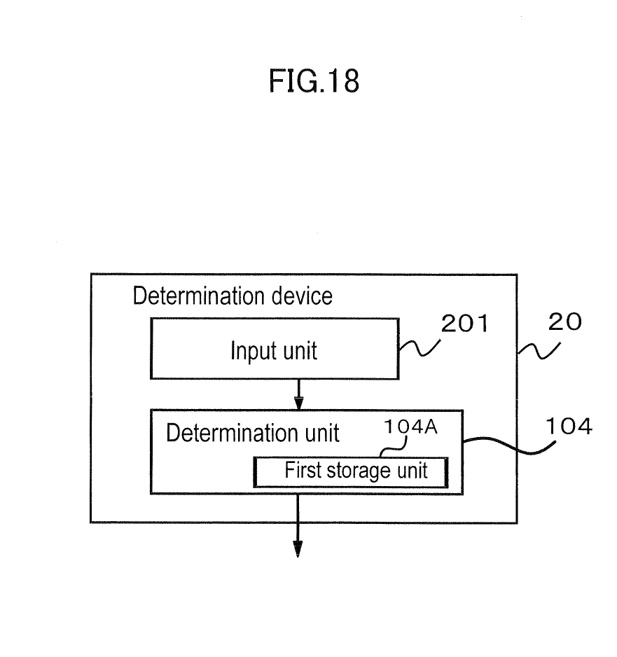

FIG. 19 is a view illustrating an assignment device according to the embodiment.

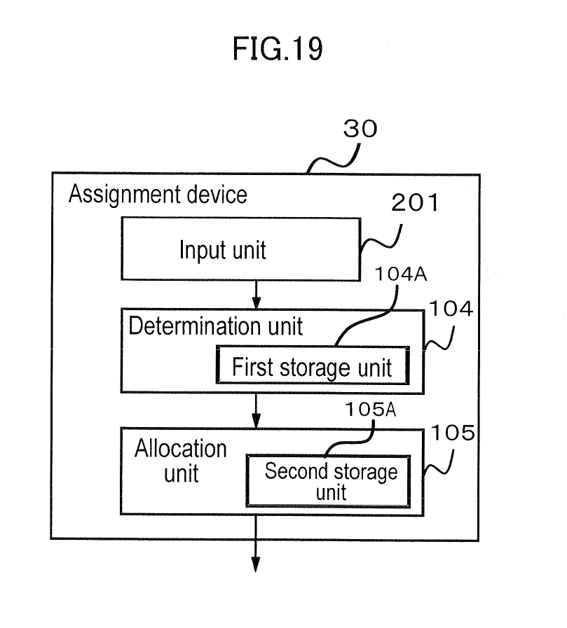

### DETAILED DESCRIPTION

According to one embodiment, A compiler device comprise :an input unit inputting a data flow graph including a set of nodes and a set of edges, and information indicating a range of values that can be taken by data flowing along each edge; a determination unit determining hardware resource candidates to which a first node can be allocated from among a plurality of different types of hardware resources based on the first node type and information indicating the range of values that can be taken by data flowing along a first edge connected to the first node and determining hardware resource candidates to which a second node can be allocated from among a plurality of different types of hardware resources based on the second node type and information indicating the range of values that can be taken by data flowing along a second edge connected to the second node; and an allocation unit determining a first hardware resource to which the first node is allocated and a second hardware resource to which the second node is allocated by using the hardware resource candidates to which the first node can be allocated and hardware resource candidates to which the second node can be allocated.

An embodiment will be described below with reference to the accompanying drawings.

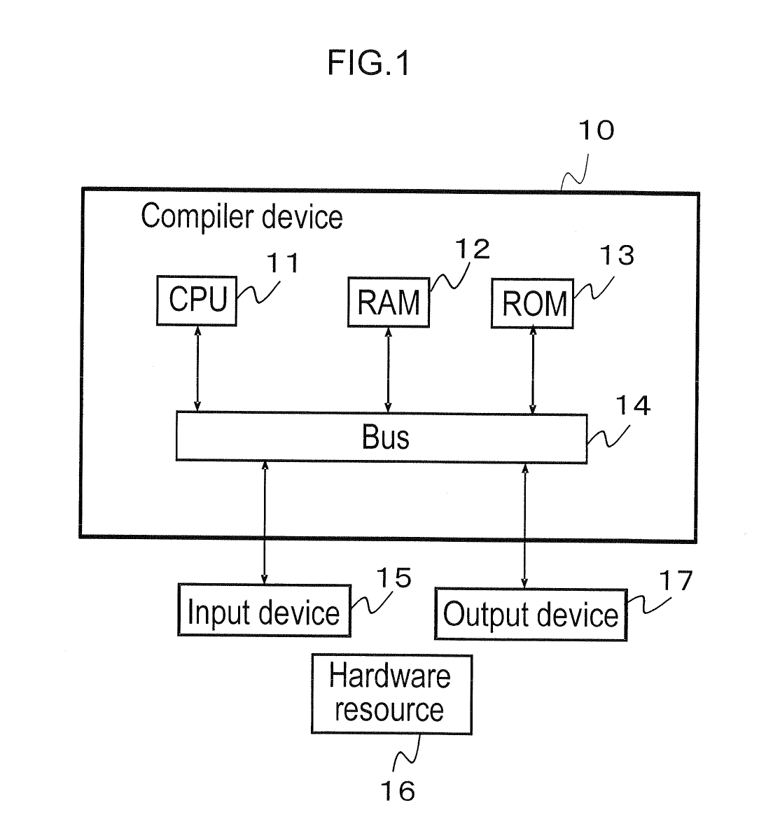

FIG. 1 is a view illustrating a configuration example of a compiler system according to the present embodiment. The compiler system includes a complier device 10, an input device 15, and an output device 17. The compiler device 10 compiles a source program to generate and output an object code. The input device 15 is a device that can input information and is, e.g., a mouse or keyboard. The output device 17 is, e.g., a monitor. The hardware resource 16 is a device that executes the object code generated by and output from the compiler device 10 by compiling the source program. The compiler device 10, input device 15, hardware resource 16, and output device 17 may be integrated each other, that is, they need not be individual devices.

The compiler device 10 includes an arithmetic processing unit (CPU 11), a main memory (RAM 12), and a read-only memory. The arithmetic processing unit (CPU 11), main memory (RAM 12), and read-only memory (ROM 13) are connected to each other through a bus 14 so as to be able to exchange data thereamong. The ROM 13 stores a program allowing the arithmetic processing unit (CPU 11) to function as the compiler device 10. This program is loaded into the main memory (RAM 12), and the CPU 11 executes the program, whereby the compiler device 10 can be realized.

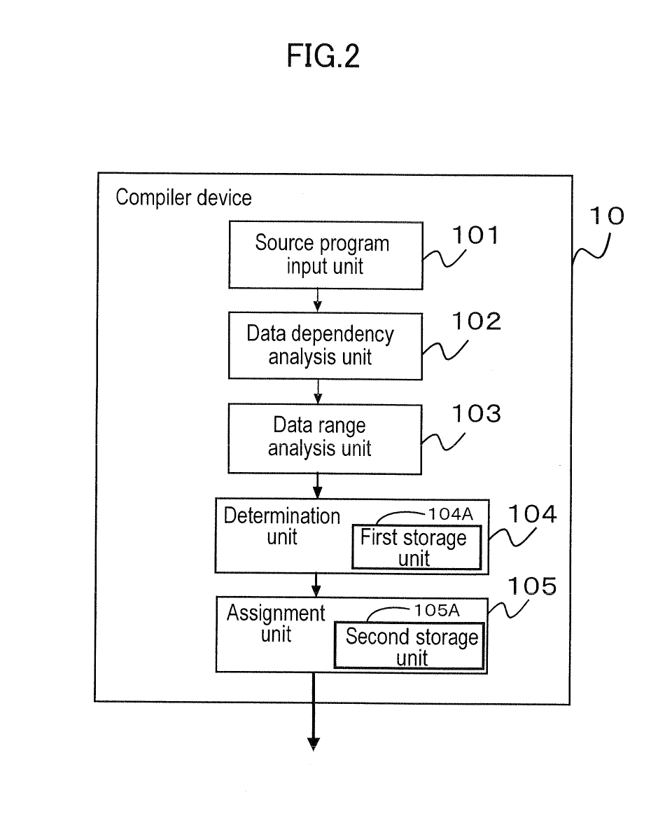

The following describes a functional configuration of the compiler device 10 thus constructed. FIG. 2 is a functional block diagram schematically illustrating the configuration of the compiler device 10. The compiler device 10 includes a source program input unit 101, a data dependency analysis unit 102, a data range analysis unit 103, a determination unit 104, and an assignment unit 105.

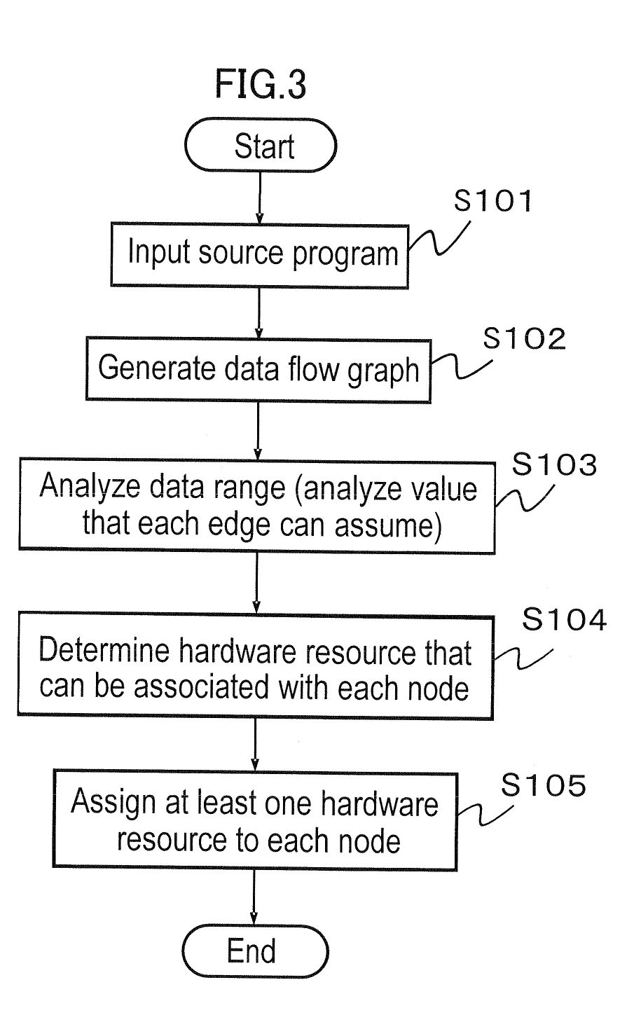

The following describes the outline of an operation of the compiler device 10. FIG. 3 is a flowchart illustrating the operation of the compiler device 10.

The compiler device 10 inputs a source program to the source program input unit 101 (S101). The data dependency analysis unit 102 generates a data flow graph from the source program (S102). The data flow graph is a graph including, as elements, a node and an edge connecting the nodes. The data range analysis unit 103 analyzes and calculates a data range of data flowing along the edge (S103). The determination unit 104 uses a result of a comparison between a type of a node and type of a process that can be processed by the hardware resource and a result of a comparison between a range that data flowing along the edge connected to the node can assume and a range of data that can be processed by the hardware resource to determine a hardware resource that can be associated with (assigned to) the node (S104). There may exist a plurality of the hardware resources that can be associated with (assigned to) each node. Then, the assignment unit 105 assigns to the node at least one of the hardware resources that have been determined by the determination unit 104 as being able to be associated with the node (S105)

The following describes the functional blocks of the compiler device 10 in the most basic embodiment in which the fundamental blocks are connected in series in the order illustrated in FIG. 2. However, the embodiment is not limited to this. For example, there can be employed a configuration in which the plurality of functional blocks act in collaboration with each other, configuration in which the connection order among the function blocks is partly changed, configuration in which a given functional block is divided into a plurality of sub-blocks, or a configuration obtained by combining the above three configurations. Further, the functional block may be performed by a plurality of modules.

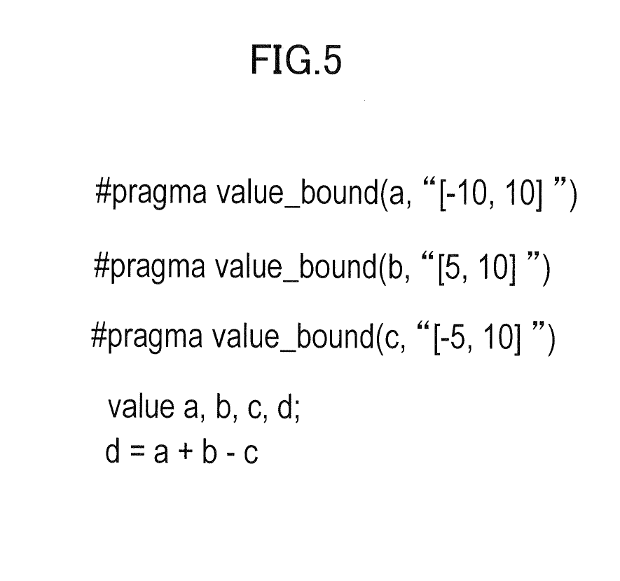

The source program input unit 101 inputs the source program into the compiler device 10. FIG. 5 illustrates an example of the source program. The source program of FIG. 5 represents that values “a”, “b”, “c”, and “d” have the following relationship: d=a+b−c. Further, <#pragma value_bound (a, “[−10, 10]”)> of the source program indicates that the data range that a can assume is [−10, 10]. Further, <#pragma value_bound (b, “[5, 10]”)> indicates that the data range that b can assume is [5, 10]. Further, <#pragma value_bound (c, “[−5, 10]”)> indicates that the data range that c can assume is [−5, 10].

The source program is a programming language such as C or Java®. The source program may be a programming language unique to the compiler device. The source program may have a data structure in which merely arithmetic operations or dependencies are arranged as data. Further, the source program need not be a text file whose structure can easily be understood by humans but may be a binary file. Further, the source program need not have a structure in which all information thereof is contained in one file but may have a structure in which the information is divided and sorted into a plurality of files.

The source program input unit 101 inputs the source program from, e.g., a file system, which is a widely accepted method. Alternatively, a method may be employed in which the source program that has already been loaded into a memory over a network is input. Further, alternatively, there are available a method in which the source program is installed in the compiler device 10, a method in which the source program are interactively input using a GUI (Graphical User Interface), and a method in which the source program is interactively input using externally provided various sensors.

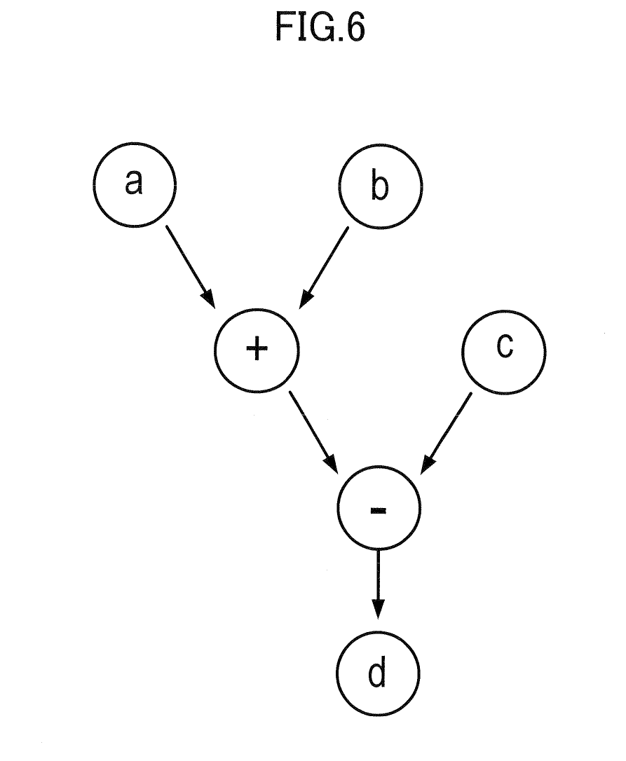

The data dependency analysis unit 102 analyzes the source program to generate the data flow graph. The graph is composed of a set of nodes (node points or apexes) and a set of edges (branches or sides) and, based on this graph, how the node is connected by the edge is made clear. FIG. 6 illustrates an example of the data flow graph.

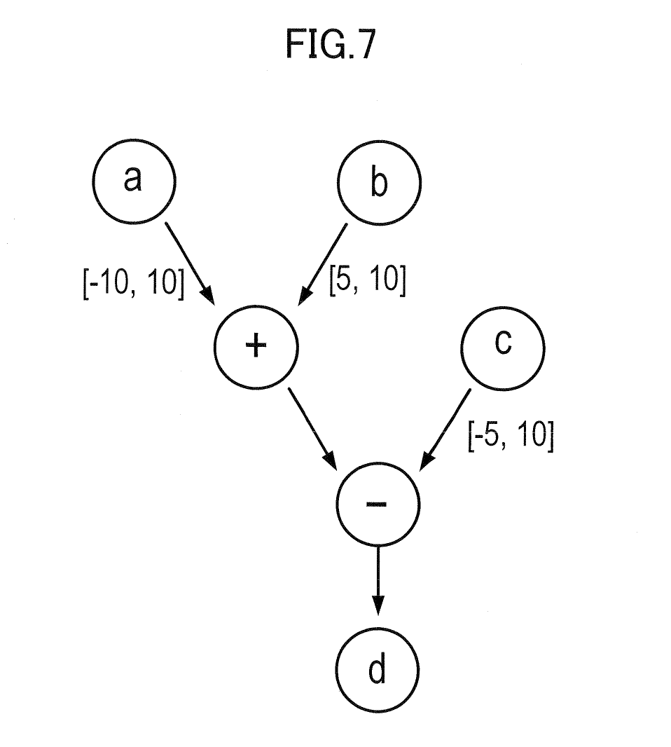

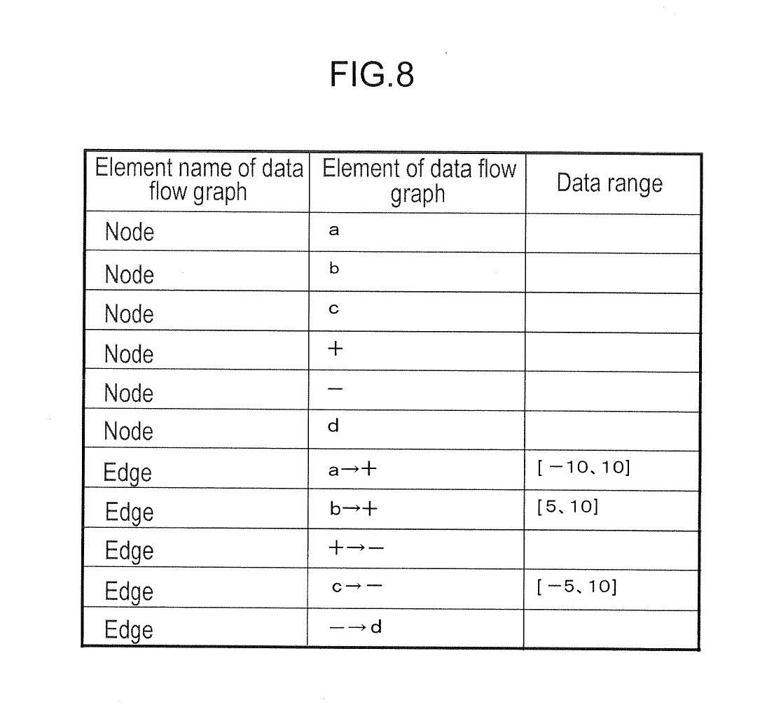

The data dependency analysis unit 102 analyzes the source program to output a data range of the edge together with the data flow graph. FIG. 7 illustrates information including the data flow graph and data range of the edge output from the data dependency analysis unit. FIG. 8 is a table representing information equivalent to FIG. 7.

The following describes a method for the data dependency analysis unit 102 to analyze the source program of FIG. 5 and output information including the data graph of FIG. 7 and data range of the edge.

An example in which the data dependency analysis unit 102 generates the data flow graph of FIG. 6 from the source program of FIG. 5 will be described. It is assumed that arithmetic operation “+” and arithmetic operation “−” of the source program of FIG. 5 have the same precedence and are left-associative and that arithmetic operation “=” has a lower precedence than other operators (arithmetic operation “+” and arithmetic operation “−”). In this case, the data flow graph of FIG. 6 can be generated from the source program of FIG. 5. In the data flow graph of FIG. 6, a value of node “a” and a value of node “b” are added “+”. Then, a value of node “c” is subtracted “−” from a value obtained as a result of the addition “+” of the nodes. Finally, the thus obtained result is substituted into “d”.

The data flow graph of FIG. 6 represents information including the plurality of nodes (node “a”, node “b”, node “+”, node “c”, node “−”, and node “d”) and plurality of edges (edge “a”→“+”, edge “b”→“+”, edge “+”→“−”, edge “c”→“−”, and edge “−”→“d”). The edge “a”→“+” is assumed to be an edge connecting node “a” and node “+”.

The following describes a method for the data dependency analysis unit 102 to output the data range of the edge shown in FIG. 7. As described above, the source program indicates that the data range that a can assume is [−10, 10]. Further, the source program indicates that the data range that b can assume is [5, 10]. Further, the source program indicates that the data range that c can assume is [−5, 10]. Thus, the data dependency analysis unit 102 outputs, together with the data flow graph, the data range [−10, 10] of the data flowing along the edge “a”→“+”, data range [5, 10] of the data flowing along the edge “b”→“+”, and data range [−5, 10] of the data flowing along the edge “c”→“−”. For example, [−10, 10] represents that the corresponding data can assume a value in the range from −10 to 10, in other words, the corresponding data cannot assume a value outside the range from −10 to 10.

The method for the data dependency analysis unit 102 to output information including the data flow graph of FIG. 7 and data range of the edge based on the source program of FIG. 5 has thus been described.

In the present embodiment, the nodes are set as arithmetic operations “+” and “−”, and the edges are set as the dependency between the arithmetic operations. However, the data flow graph may retain other information.

The data dependency analysis unit 102 need not analyze the entire source program. For example, the data dependency analysis unit 102 may analyze only a specified function. Alternatively, the data dependency analysis unit 102 may automatically select a part to be analyzed. Further alternatively, the data dependency analysis unit 102 may analyze only a specified code. Any of the above methods may be combined as needed.

The data range analysis unit 103 analyzes and outputs the range of a value that the data flowing along each edge in the data flow graph generated by the data dependency analysis unit 102 can assume. The data range analysis unit 103 may use the information indicating the range of a value that the data flowing along each edge which has been input by the input unit to output the range of a value that the data flowing along each edge.

The information indicating the range of a value that the data flowing along each edge can assume may be any form of information as long as it can indicate the range of a value that the data flowing along each edge. For example, the information may be a range of data that can flow through the edge or the width of a bit representing data that can flow through the edge. When the data range of data flowing along the edge is input from the data dependency analysis unit 102, the data range analysis unit 103 may calculate the data range of data that flows through the edge other than the input edge.

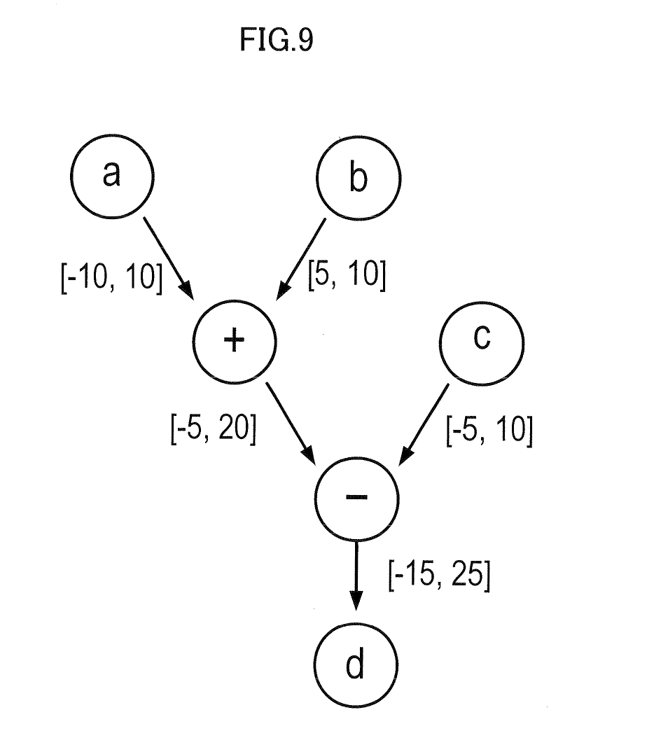

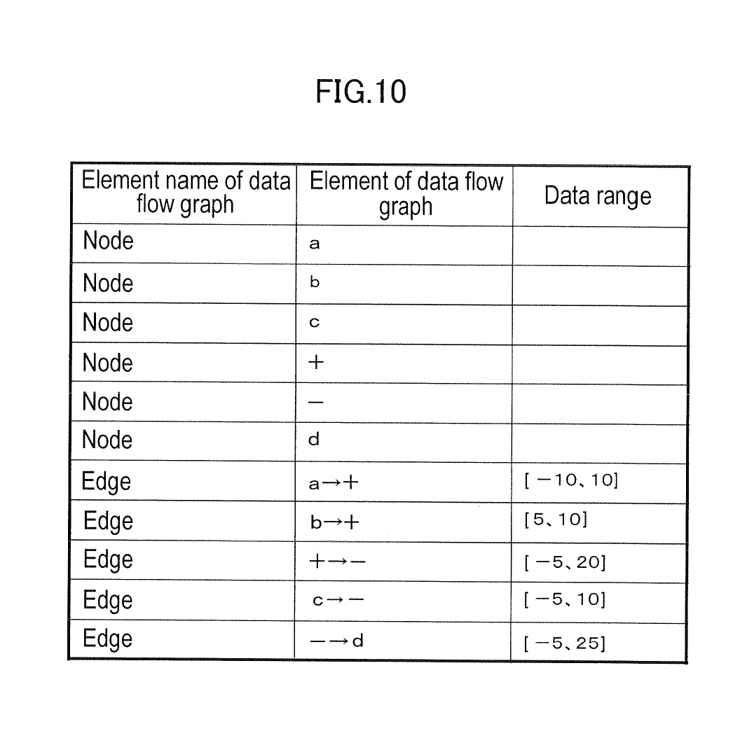

The following describes an example in which when the data dependency analysis unit 102 outputs the information illustrated in FIG. 7 including the data flow graph and data range of the edge, the data range analysis unit 103 analyzes the information to calculate the data ranges of all the edges. FIG. 9 illustrates information combining the data flow graph and data ranges of all the edges which is output from the data range analysis unit 103 as a result of the analysis performed thereby. FIG. 10 is a table representing information equivalent to the information of FIG. 9. It can be seen from a comparison between FIG. 8 and FIG. 10 that the data range analysis unit 103 outputs, in addition to the information of FIG. 8, the data range of the edge “+”→“−” and data range of the edge “−”→“d”.

The following describes an analysis method that the data range analysis unit 103 performs for outputting the information of FIG. 9 from the information of FIG. 7.

From the information of FIG. 7, as to the data range of data flowing along the edge “+”→“−”, the minimum value and maximum value obtained by adding [−10, 10] and [5, 10] are −5 (−10+5) and 20 (10+10), respectively. Similarly, as to the data range of data flowing along the edge “−”→“d”, the minimum value and maximum value obtained by subtracting [−5, 10] from [−5, 20] are −15 (−5−10) and 25 (20−(−5)), respectively. Thus, as illustrated in FIGS. 9 and 10, the data range of the edge “+”→“−” can be calculated as [−5, 20], and data range of the edge “−”→“d” can be calculated as [−15, 25].

Although only a part to which the data range of the edge has not been assigned is analyzed in this example, a part to which the edge has already been assigned may be analyzed.

For example, it is assumed that a data range of [ −100, 200] has already been assigned to the edge “−”→“d” in the data flow graph of FIG. 7. In this case, it can be seen from the analysis of the data range analysis unit 103 that [−15, 25] is enough for the data range of the edge “−”→“d”. On the other hand, it is assumed that a data range of [−1, 5] has already been assigned to the edge “−”→“d” in the data flow graph of FIG. 7. In this case, it can be seen that the assigned data range of the edge is narrower than [−15, 20] which is obtained as a result of the analysis made by the data range analysis unit 103, which indicates that the assigned data range and data range obtained as a result of the analysis conflict with each other.

In the case where the assigned data range of the edge is wider than the data range obtained as a result of the analysis, a configuration may be adopted in which whether or not the assigned data is updated with the data range obtained as a result of the analysis can be selected.

In the case where the data range of the edge narrower than that obtained as a result of the analysis is assigned, update from the assigned data range of the edge to the data range obtained as a result of the analysis need not be performed. Alternatively, the inconsistency of the result may be alarmed to a user. Further alternatively, update from the assigned data range of the edge to the data range obtained as a result of the analysis maybe performed. Further, the priority may be given to the data range of the edge in case the assigned data range of the edge and data range obtained as a result of the analysis conflict with each other.

Further, whether or not the assigned data can be updated with the data range obtained as a result of the analysis may be selected optionally.

In the case where the data ranges of all the edges in the data flow graph input to the data range analysis unit have been already assigned, the data range analysis unit may skip the analysis or may perform the analysis with a view to update of the data range of the edge or discovery of the inconsistency thereof.

Although the data range of the edge is analyzed from the top to bottom of the data flow graph in the above examples, the analysis maybe performed in any direction.

The analysis of the data range need not be analyzed for all the edges as illustrated in FIG. 9, but there may exist edges that cannot be analyzed or are not analyzed. In the case where the data range of the edge cannot be analyzed or is not analyzed, an alarm may be issued to a user of the compiler device. In this case, not only information merely indicating that the analysis cannot be made, but also detailed information indicating why and which edge in the data flow graph cannot be analyzed may be provided. In the case where the data range of the edge cannot be analyzed, a cause of the inability to perform the analysis may be removed by some input with respect to the data flow graph or processing maybe continued without the analysis. How the edge that cannot be analyzed is processed in the subsequent processing will be described later.

The data range of the edge need not directly correspond to the edge as illustrated in FIG. 5 as long as it is information that can indicate the data range of the edge. For example, a connection of the data range of input/output of the node to each node is equivalent to a connection of the data range of the edge to each edge.

To analyze the edge, one or more edges each having the data range of the edge serving as a starting point of the analysis. In the example of FIG. 7, data specified by “pragma” of FIG. 5 is used as the starting point. That is, “pragma” of FIG. 5 specifies that the data ranges of the node a, node b, and node c are [−10, 10], [5, 10], and [−5, 10]. The information of the starting point may be embedded in the source program or may be input independently of the source program.

The data range of the edge serving as the starting point may automatically be determined by the data range analysis unit 103.

Example of the method that embeds the data range of the edge in the source program include a method that utilizes a variable type such as 16-bit integer type or 32-bit integer type, a method that includes a description method of the data range in the variable naming rule, a method that utilizing a description method capable of directly describing the data range of the edge, a method that describes the data range of the edge as “pragma” for subsequent analysis, a method that describes the data range of the edge over the existing description method and perform processing at the preprocessing time, and a method that records the data range of the edge in a binary file.

Examples of the method that input the data range of the edge independently of the source program include a method that describes the data range of the edge in a file different from the source program and performs input therefrom, and a method that allows a user to interactively specify the data range of the edge through a GUI (Graphical User Interface).

Examples of the method for the data range analysis unit 103 to automatically determine the data range of the edge serving as the starting point include a method that determines that all the input unit from the memory are 16-bit data from the feature of the hardware resource, a method that estimates that the data range of the edge is limited when a given arithmetic operation is performed, and a method that determines the data range by referring to the dependency among a plurality of arithmetic operations.

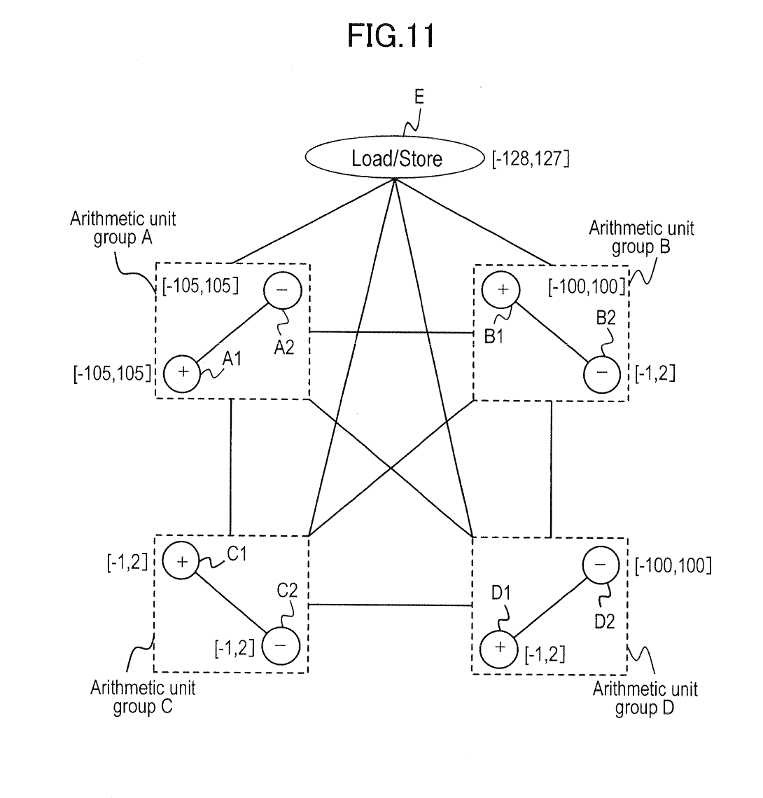

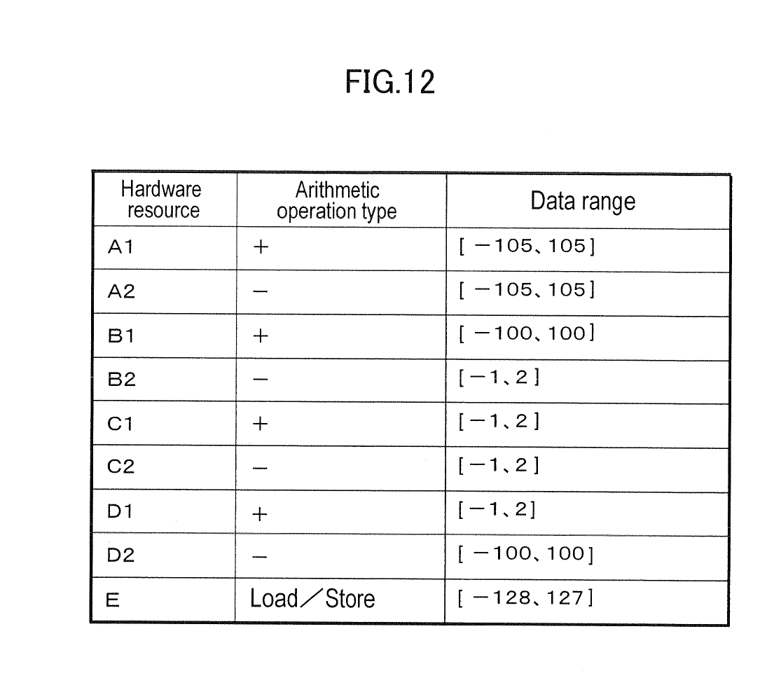

The determination unit 104 receives information (data flow graph and range that the data flowing along the edge can assume) input from the data range analysis unit 103 and determines, based on the information, the hardware resource with which the element (node or edge) of the data flow graph can be associated. The determination unit 104 includes a first storage unit 104A as illustrated in FIG. 2. As illustrated in FIG. 12, the first storage unit 104A stores the hardware resources that execute the object code generated by the compiler device 10, type of arithmetic operation of each of the hardware resources, and data range within which the arithmetic operation can perform. FIG. 11 illustrates an example of the hardware resource group executing the object code generated by the compiler device 10. The determination unit 104 determines, from among the hardware resources of the hardware resource group, a hardware resource that coincides with the type of the arithmetic operation of the node in the data flow graph and that can process all the data ranges of the edges input to the node and edges output from the node as a hardware resource that can be associated with the node. The determination unit 104 determines all the hardware resources that can be associated with any of the elements in the data flow graph as associable hardware resources. Thus, the number of the hardware resources associated with each element in the data flow graph need not be one.

For which element the determination of the association is made differs depending on characteristics of the hardware resource or a request made to the complier device 10. For example, if an arithmetic unit is heterogeneous and a data path is homogeneous, only the determination for the arithmetic unit may be made while the determination for the data path is not performed.

Whether the element in the data flow graph can be associated with the hardware resource is determined based on whether the hardware resource can execute the element in each data flow graph properly. To execute the element in each data flow graph properly, it is necessary to achieve a target arithmetic operation and to perform the arithmetic operation without losing data accuracy. To achieve the target arithmetic operation requires, when the node is, e.g., “+” (operator performing an addition), that the hardware resource is assigned to an arithmetic unit including an adder.

Further, to perform arithmetic operation without losing data accuracy, for example, it is required that the data range within which the arithmetic operation of the hardware resource can be performed includes all the data ranges of the edges input to the node and edges output from the node. For example, a condition for an adder corresponding to the arithmetic operation node “+” not to lose data accuracy is that the adder can input thereto the data range [−10, 10] of the edge “a”→“+” and data range [5, 10] of the edge “b”→“+” which are input to the arithmetic operation node “+” and can output therefrom the data range [−5, 20] of the edge “+”→“−” which is an output obtained as a result of arithmetic operation with respect to the each input. That is, it is necessary for the adder to be able to perform arithmetic operation in the data range [−10, 20]. Further, the adder that can perform arithmetic operation without losing data accuracy may be, when the node needs to perform a 32-bit addition, an adder with accuracy equal to or higher than the 32 bits.

The lost of the data accuracy does not mean that a result is not mathematically correct, that is, it is enough for the result of the arithmetic operation to fall within a required accuracy. For example, even if 0.005/100 results in 0, it can be said that this result falls within an allowable accuracy.

When the edge is assigned to a data path, it is required that the data range of data flowing along the edge can be made to flow through the data path.

The following describes the operation of the determination unit 104 using FIGS. 9, 10, 11, and 12.

The hardware resource group illustrated in FIG. 11 is constituted by arithmetic unit groups A to D each including an adder and a subtractor. In the hardware resource group, the four arithmetic unit groups and a Load/Store arithmetic unit are connected to each other. Data paths from the Load/Store arithmetic unit and data paths connected between the arithmetic unit groups are connected both to the arithmetic unit s of each arithmetic group. The arithmetic unit group A has a hardware resource A1 whose arithmetic operation type is “+ (addition)” and whose processable data range is [−105, 105] and a hardware resource A2 whose arithmetic operation type is “− (subtraction)” and whose processable data range is [−105, 105]. The arithmetic unit group B has a hardware resource B1 whose arithmetic operation type is “+ (addition)” and whose processable data range is [−100, 100] and a hardware resource B2 whose arithmetic operation type is “− (subtraction)” and whose processable data range is [−1, 2]. The arithmetic unit group C has a hardware resource C1 whose arithmetic operation type is “+ (addition)” and whose processable data range is [−1, 2] and a hardware resource C2 whose arithmetic operation type is “− (subtraction)” and whose processable data range is [−1, 2]. The arithmetic unit group D has a hardware resource D1 whose arithmetic operation type is “+ (addition)” and whose processable data range is [−1, 2] and a hardware resource D2 whose arithmetic operation type is “− (subtraction)” and whose processable data range is [−100, 100]. The Load/Store arithmetic unit is a hardware resource E. The data range of the hardware resource E is [−128, 127].

In the present embodiment, it is assumed that each data path allows passage of data of any size. That is, in the present embodiment, it is not necessary to select the data path depending on the data range of the data flowing along each edge. In the case where there is a limit to the data size that can pass through the data path, the determination unit 104 may be provided with a function of determining whether or not the data path allows passage of the data size falling within the data range based on the data range of the edge.

The concept of the arithmetic unit group refers to a set of arithmetic units that can transfer data at short times. The arithmetic unit group need not be provided with a special mechanism as the hardware resource. For example, in one arithmetic unit group, the data path between the hardware resources can transfer data in one clock cycle. The data path between the arithmetic unit groups transfer data in five clock cycles, for example.

It is assumed here that each arithmetic unit executes arithmetic operation in one clock cycle. It is assumed that the Load/Store arithmetic unit can transfer data to another hardware resource in ten clock cycles, including memory access time and data transfer time.

The following describes an example of a method of determining with which hardware resource of the hardware resource group of FIG. 11 each element of the data flow graph of FIG. 9 can be associated. Since it is assumed that each data path allows passage of any data in the present embodiment, it is not necessary to determine whether the edge of the data flow graph can be associated the data path.

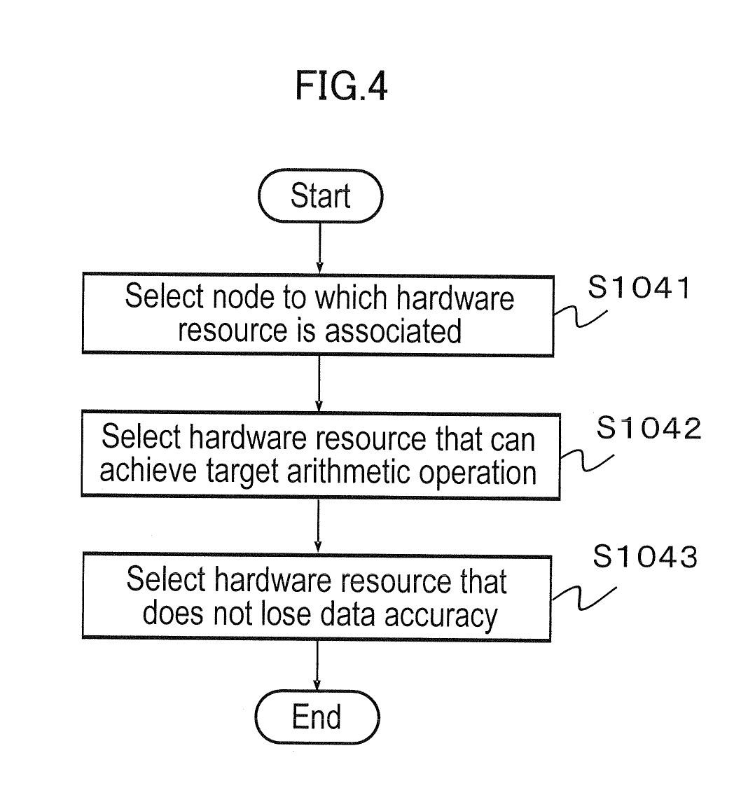

The determination is made based on whether the following two conditions are satisfied: target arithmetic operation of each node can be achieved; and arithmetic operation can be performed without losing data accuracy. In the present embodiment, the data accuracy is determined based on whether the data range that can be processed by the hardware resource includes all the data ranges of the edges input to the node and edges output from the node. For example, the steps illustrated in FIG. 4 are used to perform the determination. That is, the node to be determined is selected (S1401) and then the information of FIG. 10 input from the data range analysis unit 103 and information of FIG. 12 stored in the first storage unit 104A are compared to determine whether each hardware resource can achieve the target arithmetic operation of the node (S1402) and then to determine whether arithmetic operation can be performed that the hardware resource does not lose the data accuracy (S1403).

The arithmetic operations of the nodes a, b, c, and d of the memory access of FIG. 9 can be achieved by the hardware resource E which is the Load/Store arithmetic unit. The data ranges of the edges output from the nodes a, b, and c and the data ranges of the edges input to the node d are included in [−128, 127] which is the readable/and writable data range of the Load/Store arithmetic unit. Thus, it is determined that the nodes a, b, c, and d can be associated with the Load/Store arithmetic unit.

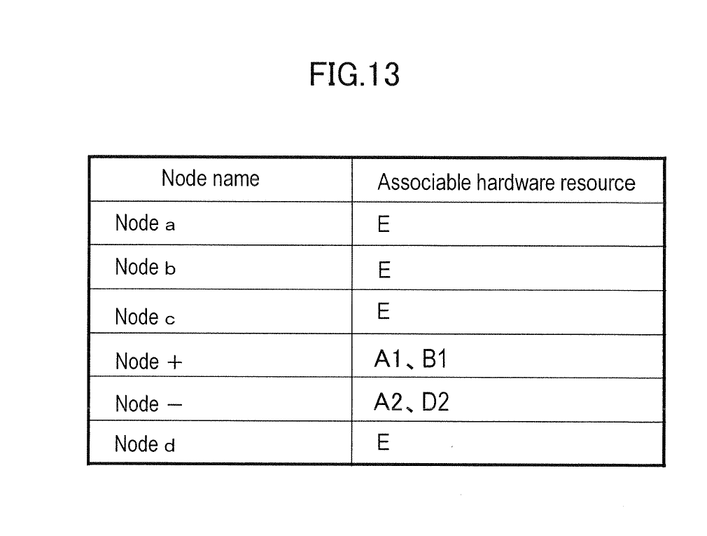

The node “+” of FIG. 9 is an operator of an addition. Thus, it is determined from the table of FIG. 12 that the hardware resources A1, B1, C1, and D1 perform arithmetic operation of the node “+”. The edges input to the node “+” are “a”→“+” (data range [−10, 10]) and “b”→“+” (data range [5, 10]). The edge output from the node “+” is “−”→“d” (data range [−5, 20]). Thus, the hardware resource needs to be an arithmetic unit that can process the data range [−10, 20]. As a result, it can be determined from the table of FIG. 12 that the hardware resources A1 and B1 can be associated with the node “+”. Similarly, it is determined that the hardware resources A2 and D2 can be associated with the node “−” of FIG. 9. FIG. 13 represents information including the nodes and hardware resources that can be associated with the nodes which are determined and output by the determination unit 104.

The node type is not limited to a variable node and addition. For example, the node type includes various arithmetic operations from low-level to high-level arithmetic operations, including a combination of the addition and multiplication, FFT (Fast Fourier Transform), H.264 decoding. One data flow graph may include both the low-level and high-level arithmetic operations. The node type may be not only an arithmetic operation but also a logical arithmetic operation, memory operation, conditional branching, complex arithmetic operation, stack operation, data transfer, function call, or function return.

The hardware resource is not limited to the adder. The hardware resource may be, for example, a multiplier, an arithmetic unit performing an addition of plurality of data under SIMD (Single Instruction Multiple Data) mode, each adder included in the arithmetic unit performing an addition of plurality of data under SIMD mode, an arithmetic unit like an ALU (Arithmetic Logic unit) that can perform a plurality of types of arithmetic operations and can selectively perform the arithmetic operations, an arithmetic unit like an ALU array obtained by connecting the plurality of ALU, an arithmetic unit like FFT (Fast Fourier Transform) performing a specific arithmetic operation, an arithmetic unit performing H.264 decoding, a multicore obtained by connecting a plurality of processor cores, a multiprocessor obtained by connecting a plurality of processors, and the like. The hardware resource may be either a low-level arithmetic unit or high-level arithmetic unit. Low-level arithmetic units and high-level arithmetic units may be mixed in a hardware resource group. Further, the hardware resource includes not only the arithmetic unit but also the data path connecting the arithmetic units.

The hardware resources may be viewed hierarchically from the compiler device. For example, information indicating that the low-level arithmetic unit is included in the high-level arithmetic unit may be retained for use in determination. For example, when an arithmetic unit performing an addition and the subtraction is regarded as one arithmetic unit, the information indicating that the arithmetic unit includes both the adder and subtractor may be used. That is, for example, an addition of 10 can be achieved by an addition of 10 and subtraction of 0, so that this arithmetic unit may be determined to be associable. As a result, the number of the arithmetic units determined to be associable is increased.

The determination of associable or not is made to one or more hardware resources. In the case where the determination is made to one hardware resource, “associable” or “not associable” is obtained as a result of the determination. In this case, various methods are available for selecting the one hardware resource to be determined. For example, there can be considered a method selecting a hardware resource at random, a method preferentially selecting a hardware resource positioned near a memory, a method selecting a hardware resource according to an algorithm used, a method selecting a hardware resource positioned near a hardware resource, if exists, to which the element has already been assigned, a method preferentially selecting a hardware resource that can perform powerful arithmetic operation, a method selecting a hardware resource positioned near a wider data path, a method selecting a hardware resource positioned near the logical center so as to minimize the length of a path to each hardware resource, and a method combining the above-mentioned methods. In the case where the determination is made to one or more hardware resources, a set of associable hardware resources, a subset of associable hardware resources, or the like is obtained as a result of the determination.

The determination unit 104 may externally receive information indicating that a given node of the data flow graph can be associated or cannot be associated with a specific hardware resource. For example, when receiving information indicating that a given hardware resource needs to be used for processing different from the arithmetic operation of the node of the data flow graph, the determination unit 104 does not determine that the hardware resource can be associated with all the nodes of the data flow graph. Examples of a method for the determination unit to externally receive the information include a method in which the information is input from an external file and a method in which the information is interactively specified as a property of the node through a GUI (Graphical User Interface). The information externally supplied may be one specifying the relationship between all the nodes of the data flow graph and hardware resources or relationship between some of the nodes and hardware resources.

When there is no associable hardware, the determination unit 104 issues an alarm to a user of the compiler device 10 or another device. For example, information of the node or edge to which the hardware resource cannot be assigned may be displayed on a console, or the alarm may be notified using an inter-process communication. It is possible to optionally specify whether or not the alarm is issued or to specify the level of detail of the information included in the alarm.

When the information input to the determination unit 104 includes an edge whose data range is unknown, the determination unit 104 can take various methods. For example, there are available a method in which the determination unit 104 determines an occurrence of an error and stop the processing, a method in which the determination unit 104 determines that a hardware resource whose processable data range is largest among the hardware resources that can achieve arithmetic operation of the node can be associated with the node, a method in which the determination unit 104 determines that a hardware resource can randomly be selected from the hardware resources that can achieve arithmetic operation of the node so as to be associated with the node, and a method in which the determination unit 104 determines that, from among the hardware resources that can achieve arithmetic operation of the node, a hardware resource having a data range larger than a given threshold can be associated with the node.

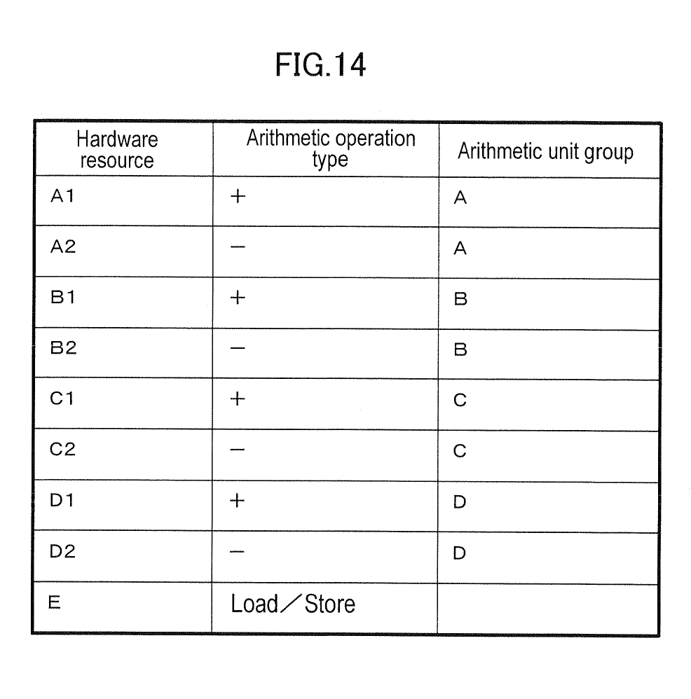

The assignment unit 105 assigns at least one of the hardware resources that have been determined to be associable with each element of the data flow graph by the determination unit 104. The assignment unit 105 has a second storage unit 105A that stores hardware resource management information. An example of the hardware resource management information stored in the second storage unit 105A is represented in FIG. 14. As illustrated in FIG. 14, the second storage unit 105A stores, as the hardware resource management information, information indicating to which arithmetic unit group the hardware resource belongs.

The assignment unit 105 performs assignment of the hardware resource to each element of the data flow graph based on the dependency in the data flow graph and hardware resource management information.

The dependency in the data flow graph is, e.g., the dependency between the nodes. For example, in FIG. 7, there is a dependency that processing of the node “+” is performed before processing of the node “−”. Further, the dependency may include a dependency concerning the hardware resource that can be associated with each node.

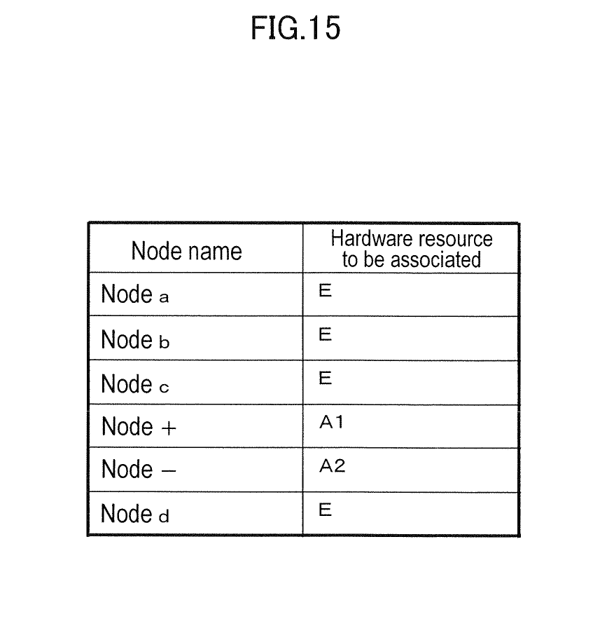

The following describes an operation of the assignment unit 105 using FIGS. 13, 14, and 15. FIG. 15 is a table representing the hardware resource assigned to each node by the assignment unit 105.

As illustrated in FIG. 13, the nodes a, b, c, and d are determined to be able to be associated with one Load/Store arithmetic unit (hardware resource E) by the determination unit 104. Accordingly, the assignment unit 105 assigns the Load/Store arithmetic unit (hardware resource E) to the nodes a, b, c, and d.

As illustrated in FIG. 13, the node “+” is determined to be able to be associated with the hardware resource A1 and hardware resource B1 by the determination unit 104. The node “−” is, as illustrated in FIG. 13, determined to be able to be associated with the hardware resources A2 and D2 by the determination unit 104. It can be seen from the hardware resource management information that the hardware resources A1 and A2 belong to the same arithmetic unit group. Further, as is clear from the data flow graph, there is a dependency that processing of the node “+” is performed before processing of the node “−”.

In the present embodiment, the assignment unit 105 assigns the hardware resource to the node in consideration that the processing can be executed as early as possible. The assignment unit 105 assigns the hardware resource to the node based on information concerning the arithmetic unit group to which the hardware resource belongs and dependency between the nodes. In the case where the hardware resources exist in the same arithmetic unit group, data can be transferred over the data path between the hardware resources in one clock cycle. In the case where the hardware resources exist in the different arithmetic unit groups, data can be transferred over the data path between the hardware resources in five clock cycles.

As described above, the number of clock cycles required for one arithmetic operation is 10 clock cycles (one clock cycle for addition, one clock cycle for subtraction, and 10 clock cycles for writing of data from subtractor into memory).

Accordingly, when the node “+” and node “−” are assigned to the hardware resources belonging to the same arithmetic unit group, a total of 23 clock cycles are required for accomplishing the processing of the entire data flow graph.

On the other hand, when the node “+” and node “−” are assigned to the hardware resources belonging to the different arithmetic unit groups, more specifically, when the hardware resource B1 is assigned to the node “+”, and hardware resource D2 is assigned to the node “−”, 5 clock cycles are required for transferring data from the hardware resource B1 to hardware resource D2, with the result that a total of 27 clock cycles are required for accomplishing the processing of the entire data flow graph.

The assignment unit 105 assigns the hardware resource A1 to the node “+” and assigns the hardware resource A2 to the node “−”.

In the present embodiment, the assignment unit 105 assigns the hardware resource that can execute the arithmetic operations as fast as possible by using the information concerning the arithmetic unit group to which the hardware resource belongs as the hardware resource management information. However, the hardware resource management information is not limited to information concerning the arithmetic unit group. Further, it is not always necessary to assign the hardware resource that can execute the arithmetic operations as fast as possible to the node.

The hardware resource management information includes various information. The hardware resource management information covers wide range of information concerning an assignment algorithm such as an assignment state in addition to information concerning the hardware resource itself, such as information on the node and hardware resource which have already been assigned to each other by the algorithm, information on the node which is now assigned by the algorithm and hardware resource that can be associated with the node, information on the delay of the data path between the hardware resources, information on the execution time of the hardware resource, information on the power consumption of the hardware resource, and information on the heat distribution of the hardware resource.

The assignment unit 105 may externally receive specification of the assignment of the hardware resource so as to assign the hardware resource to the node. For example, when a given node “+” needs to be assigned to a specific adder, the corresponding information may be externally input. Examples of the input method include a method in which the information is input from an external file and a method in which the information is interactively specified as a property of the node through a GUI (Graphical User Interface). Further, the external specification of the hardware resource assignment need not be assignment of one hardware resource to the node, but may be assignment of any of a plurality of hardware resource candidates to the node. Further, the specification may be performed in such a way that any of the arithmetic units located at a lower hierarchy of a given arithmetic unit is to be assigned. Further, a coercive force may be given to the external specification of the hardware resource assignment or “wishful” specification may be made. When the “wishful” specification is made, the assignment unit 105 tries to assign the element to the specified hardware resource. In this case, when it is determined that the assignment is not possible or desired effect cannot be obtained, the element may be assigned to another hardware resource.

The assignment unit 105 may issue an alarm when there is no assignable hardware resource. For example, information indicating that the node “+” performing an addition of the data widths [200, 300] cannot be assigned to any of the hardware resources of FIG. 11 is represented. In this case, the assignment unit 105 may determine an occurrence of an error, may assign the node to a hardware resource whose processable data width is large, or may randomly assign the node to the hardware resource.

The assignment unit 105 may create the assignable hardware resource on a programmable device. For example, it is assumed that a specialized hardware resource like the adder and programmable device like an FPGA are connected. In this case, if the data range of the adder as the specialized hardware resource within which arithmetic operation can be performed is insufficient, an adder satisfying the data range within which arithmetic operation can be performed may be created. The assignment unit 105 may create a new hardware resource on the programmable device even when there exists the assignable hardware resource. Various situations can be assumed for this, in which although the prepared specialized adder suffices in the above example of the hardware resource, the adder as the specialized hardware resource needs to be used for another addition or it is determined, based on the dependency relationship with another arithmetic operation and hardware resource management information, that the arithmetic operation needs to be assigned to the FPGA close to the previous arithmetic operation. When the programmable device exists, the determination unit 104 may notify the assignment unit 105 of the information that the element can always be associated with the programmable device. Alternatively, a configuration may be possible in which the determination unit 104 does not explicitly notify the assignment unit 105 of the above information because the determination unit 104 can freely create a new arithmetic unit.

According to the complier device 10 of the present embodiment, in the case where a plurality of hardware resources that execute the object code, it is possible to efficiently utilize the hardware resources without losing the data accuracy.

The following are other methods for the assignment unit 105 to assign the hardware resource to the node.

A case where the hardware resource group that executes the object code output from the compiler device 10 includes a hardware resource having the SIMD arithmetic unit 11 be described. In this case, when the determination unit 104 determines that a plurality of nodes can be associated with the SIMD unit, the assignment unit 105 collectively assigns the plurality of nodes to the SIMD arithmetic unit. This can process plurality of data in bulk thereby reducing the processing time as compared to a case where the arithmetic operations are individually performed.

The assignment unit 105 may perform the hardware resource assignment with a view to, e.g., a reduction of object size. For example, it is assumed that the hardware resources A1 and A2 each support various arithmetic operations and thus each require 32 bits for specification of the arithmetic operations and that the other hardware resources each support an addition and a subtraction and thus each require 1 bit for the specification of the arithmetic operations. In this case, when the hardware resource A1 is assigned to the node “+” and arithmetic unit A2 is assigned to the node “−”, a total of 64 bits are used for the specification of the arithmetic operations. On the other hand, in the case where the hardware resource B1 is assigned to the node “+” and hardware resource D2 is assigned to the node “−”, a total of 2 bits are enough. Thus, the object size can be reduced.

The assignment unit 105 may perform the hardware resource assignment with a view to, e.g., a reduction of required memory amount. For example, it is assumed that the hardware resources A1 and A2 are each a stack machine and thus each need to store data required for the arithmetic operation in the memory and that the other hardware resources each have a register and thus each can load therein the data required for the arithmetic operation. In this case, when the hardware resource B1 is assigned to the node “+” and hardware resource D2 is assigned to the node “−”, the required memory amount can be reduced as compared to a case where the hardware resources A1 and A2 are assigned respectively to the nodes “+” and “−”.

The assignment unit 105 may perform the hardware resource assignment with a view to, e.g., a reduction of power consumption. For example, it is assumed that the hardware resources A1 and A2 are each a powerful arithmetic unit and thus require much power and that the other hardware resources each require less power than the hardware resources A1 and A2. In this case, when no node is assigned to the hardware resources A1 and A2, the power consumption may be reduced by applying a clock gating technology or the like to the hardware resources A1 and A2.

The assignment unit 105 may perform the hardware resource assignment with a view to, e.g., a reduction of generated heat. For example, frequently use of only a certain hardware resource causes heat to concentrate at a specific area; while distributed use of different hardware resources may dissipate the heat. Thus, the assignment unit 105 achieves the reduction of heat by utilizing various hardware resources.

The assignment unit 105 may perform the assignment with a view to, e.g., a reduction of required hardware resource amount. For example, assumed is a case where there are a plurality of processing tasks to be executed and where these processing tasks need to be executed simultaneously. This means that when the plurality of processing tasks are time-divided, a time pressure required for the execution of the processing tasks cannot be satisfied. In this case, the assignment unit 105 assigns the processing of the node “+” and node “−” only to the hardware resources A1 and A2 and keeps the other hardware resources for other processing tasks, which may allow different processing tasks to be executed simultaneously.

Although an example in which each element of the data flow graph is assigned to one hardware resource has been described, the determination unit 104 may determine that each element of the data flow graph can be assigned to a plurality of hardware resources.

For example, assumed is a case where the edge of the data flow graph requiring an accuracy of 64 bits is assigned to the data path of the hardware resource. The determination unit 104 may separate the upper 32-bit data and lower 32-bit data of the 64-bit data expressed by the edge of the data flow graph and determine that the separated edges can be assigned to two 32-bit data paths.

As described above, by regarding one edge of the data flow graph as a plurality of edges, the determination unit 104 can determine that each element of the data flow graph can be assigned to a plurality of hardware resources. This can apply not only to the data path but also to the arithmetic unit. For example, when a bit-based logical disjunction between two 64-bit data is performed, it can be determined that the upper 32-bit data and lower 32-bit data can be assigned to two different 32-bit arithmetic units. When the determination unit 104 determines that one element of the data flow graph can be assigned to a plurality of hardware resources, the assignment unit 105 performs assignment, with the assignment method taken into consideration.

The information indicating the value range that the data flowing along the edge can assume is not limited to information indicating one data range. For example, the information indicating the value range that the data flowing along the edge can assume may be represented as a set of values that can flowing along the edge. For example, the value that can flowing along the edge may be represented as (1, 2, 5, 8). This means that the edge can assume one of values 1, 2, 5, and 8. The information indicating the value range that the data flowing along the edge can assume may be represented as a set of a plurality of data ranges, such as [12, 20] [50, 75]. This means that the value of the data flowing along the edge falls within a range of 12 to 20 or a range of 50 to 75.

Although all the values of the data flowing along the edge are represented as integers in FIG. 7, they may be represented as any numeric values other than the integer. For example, the value of the data flowing along the edge may be represented using decimal fraction, matrix, or complex number.

The value of the data flowing along the edge may be represented using a bit width. The following describes a case where the value of the data flowing along the edge is represented as the bit width.

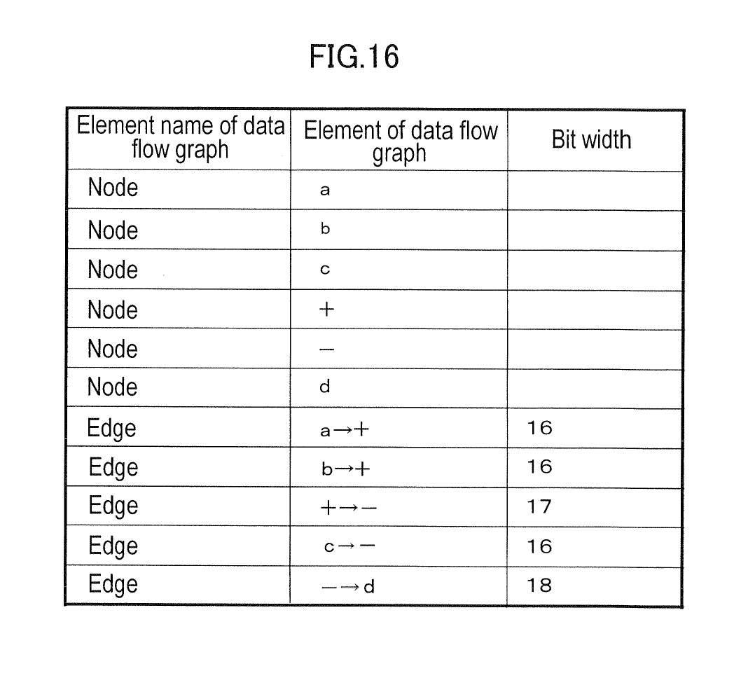

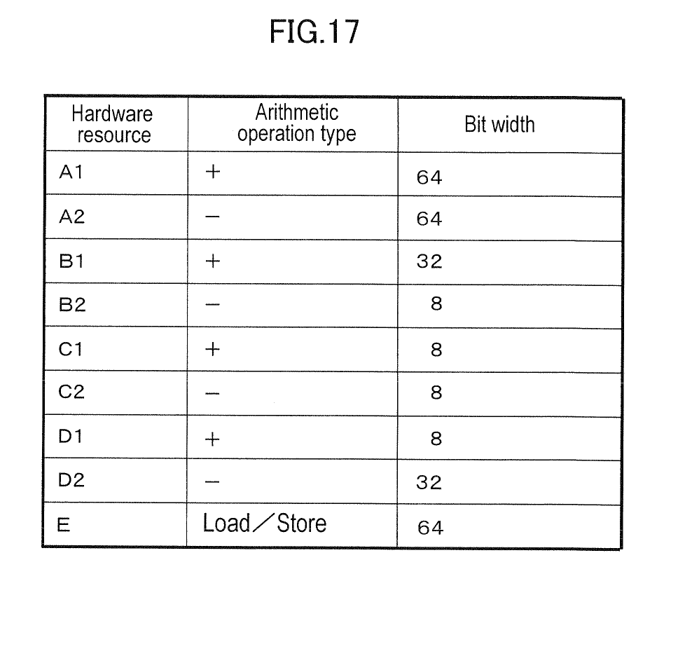

In this case, the variables a, b, c, and d of the source code of FIG. 5 are represented not as the data range but as the bit width. Further, the values of the data flowing along the edge in FIGS. 7, 8, 9, and 10 are also represented as the bit width in place of the data range. Further, the processing amount of the hardware resource is represented not as the data range but as the bit width. The first storage unit 104A of the determination unit 104 stores a correspondence table of FIG. 17 representing a correspondence between the hardware resource and bit width. FIG. 16 is a correspondence table between the element of the data flow graph and bit width of the edge in the case where the value of the data flowing along the edge in the data flow graph of FIG. 9 is represented as the bit width.

The determination unit 109 compares the bit width of data input to each node, bit width of data output therefrom, and bit width of data that each hardware resource can process. When the bit width of the data that each hardware resource can process is larger, the determination unit 104 determines that the hardware resource is an associable hardware resource. For example, in FIG. 16, the bit widths of “a”→“+” which is the output edge of the node a, “b”→“+” which is the output edge of the node b, “c”→“−” which is the output edge of the node c, and “−”→“d” which is the input edge of the node d are 16, 16, 16, and 18, respectively. The bit width of data that the hardware resource E can process is 64. Thus, the determination unit 104 determines that the hardware resource E can be associated with all the nodes a, b, c, and d. The bit widths of “a”→“+” and “b”→“+” which are the input edge of the node “+” are 16, respectively. The bit width of “+”→“−” which is the output edge of the node “+” is 17. Thus, the determination unit 104 determines, by referring to FIG. 17, that the node “+” can be associated with the hardware resources A1 and B1. The bit width of “c”→“−” which is the input edge of the node “−” is 16, bit width of “+”→“−” which is the input edge of the node “−” is 17, and bit width of “−”→“d” which is the output edge of the node “−” is 18. Thus, the determination unit 104 determines, by referring to FIG. 17, that the node “−” can be associated with the hardware resources A2 and 92.

In the present embodiment, a determination device 20 that does not include the source program input unit 101, data dependency analysis unit 102, data range analysis unit 103, and assignment unit 105 of the compiler device 10 may be independently provided. The determination device 20 includes an input unit 201 and a determination unit 104. The input unit 201 inputs the data flow graph (node and edge) and range of data flowing along the edge. The determination unit 104 performs the same operation as that performed by the determination unit 104 in the compiler device 10. The determination device 20 may include the source program input unit 101, data dependency analysis unit 102, data range analysis unit 103, and determination unit 104.

In the present embodiment, an assignment device 30 that does not include the source program input unit 101, data dependency analysis unit 102, and data range analysis unit 103 of the compiler device 10 may be independently provided. The assignment device 30 includes an input unit 201, a determination unit 104, and an assignment unit 105. The input unit 201 performs the same operation as that performed by the input unit 201 provided in the determination device 20. The determination unit 104 and assignment unit 105 perform the same operations as those performed by the determination unit 104 and assignment unit 105, respectively, in the compiler device 10.

The determination device 20 and assignment unit 30 make it possible to efficiently utilize hardware resources without losing data accuracy.

The compiler device 10 can be realized by using, e.g., a general-purpose computer as basic hardware resource. That is, the source program input unit 101, data dependency analysis unit 102, data range analysis unit 103, determination unit 104, and assignment unit 105 can be realized by a processor mounted on the computer executing a program. In this case, the compiler device 10 may be realized by previously installing the program in the computer or realized by distributing the program through a storage medium such as a CD-ROM onto which the program is stored or through a network and installing the program in the computer according to the need. The first storage unit 104A and second storage unit 105A can be realized by using, according to the need, a memory incorporated in or externally connected to the computer, a hard disk, or a storage medium such as a CD-R, a CD-RW, a DVD-RAM, or DVD-R.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A compiler device comprising:
an input unit inputting a data flow graph including a set of nodes and a set of edges, and information indicating a range of values that can be taken by data flowing along each edge;
a determination unit determining hardware resource candidates to which a first node can be allocated from among a plurality of different types of hardware resources based on the first node type and information indicating the range of values that can be taken by data flowing along a first edge connected to the first node and determining hardware resource candidates to which a second node can be allocated from among a plurality of different types of hardware resources based on the second node type and information indicating the range of values that can be taken by data flowing along a second edge connected to the second node; and
an allocation unit determining a first hardware resource to which the first node is allocated and a second hardware resource to which the second node is allocated by using the hardware resource candidates to which the first node can be allocated and hardware resource candidates to which the second node can be allocated.

2. The compiler device according to claim 1, wherein
the determination unit includes a storage unit storing the type of a process that can be executed by each hardware resource and data value range that can be processed by each hardware resource,
the determination unit determines a hardware resource that can process the type of a process corresponding to the first node and whose processable data range includes the range of values that can be taken by data flowing along the first edge as a hardware resource candidate that can be allocated to the first node and
determines a hardware resource that can process the type of a process corresponding to the second node and whose processable data range includes the range of values that can be taken by data flowing along the second edge as a hardware resource candidate that can be allocated to the second node.

3. The compiler device according to claim 1, wherein
the allocation unit determines, from among the hardware resource candidates that can be allocated to the first node, the first hardware resource to which the first node is allocated by using a dependency between the nodes and connection relationship between the hardware resources and
determines, from among the hardware resource candidates that can be allocated to the second node, the second hardware resource to which the second node is allocated by using dependency between the nodes and connection relationship between the hardware resources.

4. The compiler device according to claim 1, wherein
the range of values that can be taken by data flowing along the edge and data range that can be processed by the hardware resource are represented by bit width.

5. A compiler device comprising:
a source program input unit inputting a source program;
a first analysis unit analyzing the source program using a data flow graph including a set of nodes and a set of edges;
a second analysis unit analyzing a range of values that can be taken by data flowing along the edge;
a determination unit determining hardware resource candidates that can be allocated to a first node based on the first node type and information indicating the range of values that can be taken by data flowing along a first edge connected to the first node and determining hardware resource candidates that can be allocated to a second node based on the second node type and information indicating the range of values that can be taken by data flowing along a second edge connected to the second node; and
an allocation unit determining a first hardware resource to which the first node is allocated and a second hardware resource to which the second node is allocated by using the hardware resource candidates to which the first node can be allocated and hardware resource candidates to which the second node can be allocated.

6. A computer-readable non-transitory storage medium storing a program for causing a computer to execute a compiler device, comprising:
inputting a data flow graph including a set of nodes and a set of edges, and information indicating a range of values that can be taken by data flowing along each edge;
determining hardware resource candidates to which a first node can be allocated from among a plurality of different types of hardware resources based on the first node type and information indicating the range of values that can be taken by data flowing along a first edge connected to the first node and determining hardware resource candidates to which a second node can be allocated from among a plurality of different types of hardware resources based on the second node type and information indicating the range of values that can be taken by data flowing along a second edge connected to the second node; and
determining a first hardware resource to which the first node is allocated and a second hardware resource to which the second node is allocated by using the hardware resource candidates to which the first node can be allocated and hardware resource candidates to which the second node can be allocated.
